(19) United States
(12) Patent Application Publication
(10) Pub. No.: US 2025/0286826 A1
(43) Pub. Date: Sep. 11, 2025

(54) DYNAMIC MTU MANAGEMENT IN AN ENTERPRISE NETWORK

(71) Applicant: CELONA, INC., Campblee, CA (US)

(72) Inventor: Vijayaraghavan Krishnaswamy, Campbell, CA (US)

(73) Assignee: CELONA, INC., Campbell, CA (US)

(21) Appl. No.: 19/196,423

(22) Filed: May 1, 2025

Related U.S. Application Data
(63) Continuation-in-part of application No. 17/985,478, filed on Nov. 11, 2022, now Pat. No. 12,294,527.
(60) Provisional application No. 63/279,010, filed on Nov. 12, 2021.

(51) Int. Cl. H04L 47/36; H04L 1/00; H04L 43/16

(52) U.S. Cl. CPC H04L 47/365; H04L 1/0007; H04L 43/16

(57) ABSTRACT

Various embodiments of a method and apparatus are disclosed. A higher MTU (Maximum Transmit Unit) between the network Core and the eNBs/gNodeBs (Evolved Node Bs/5^{th} generation Node B) or other AP (Access Point) of the network is configured, as well as in wireless RAN (Random Access Network) segments. These MTUs are dynamically adjusted to allow for the most efficient choices of packet size according to the capabilities of the UE (User Equipment) and radio conditions.

### CROSS-REFERENCE TO RELATED APPLICATIONS

The present application is a Continuation-In-Part Application of U.S. patent application Ser. No. 17/985,478, filed Nov. 11, 2022, for a “Dynamic MTU Management in an Enterprise Network,” U.S. Pat. No. 12,294,527, issued May 6, 2025, which claims priority benefit of U.S. Provisional Application No. 63/279,010, filed Nov. 12, 2021, which are each, herein, incorporated by reference in their entirety.

### BACKGROUND

### (1) Technical Field

The disclosed method and apparatus relate generally to communication systems. In particular, the disclosed method and apparatus relate to a method and apparatus for efficient communication of information by selection of the amount of information to be included in transmitted packets.

### (2) Background

Traffic between a core network and BS/AP (base station/access point) usually has a 1500-byte MTU (maximum transmission unit). For brevity, in this specification, the term “AP” is generic to both a BS and an AP, unless indicated otherwise. The AP is typically a Wi-Fi access point or wireless telephone network base station, such as a 4G (4th generation cellular network) eNB (evolved NodeB for 4G) or 5G (5th generation cellular network) gNB (gNodeB) or other hardware that is connected to the mobile phone network that communicates directly wirelessly with UE (User Equipment, which may also be referred to as a “User Equipment device” or UE device), such as a mobile handset. However, as the data passes through the various devices of the network, each device may add additional overhead data to the data packet. The overhead data may include encapsulations, encryption information, control information and metadata, in headers and trailers, for example. Each such encapsulation reduces the end-user “application” throughput. Increasing overhead/encapsulation information decreases the payload size (the payload is the information the user intends to send, and the maximum size of the payload for a given message is the size of the message minus the overhead data).

Enterprise networks, in some embodiments, include cellular or Wi-Fi networks and are typically well-administered networks, unlike the Internet. The equipment used may support a higher MTU (that is, an MTU higher than the minimum MTU offered by the EPC for network communications). The wireless RAN (Radio Access Network) packet transport capacity increases with the use of a higher modulation scheme, a higher MIMO (multi-in-multi-out) capability and higher carrier aggregation. Accordingly, using such techniques allows the amount of data that can be communicated by the packets, and that conforms to the MTU in the network, to be greater. Increasing the data per packet reduces the ratio of the overhead to the payload transmitted through the network. Increasing the MTU increases the maximum size of the packets capable of being transmitted, thus potentially increasing the payload-to-overhead ratio. Accordingly, the system and all network elements can transmit user traffic more effectively. However, network packet losses and air link issues can reduce the throughput. In this specification, the terms packet and message and the terms packet loss and message loss are used interchangeably unless indicated otherwise. In addition to needing to retransmit packets, relatively small errors in a large packet cause or require the retransmission of the entire large packet. Therefore, while it is more efficient to transmit large packets to increase the ratio of the payload to the overhead (i.e., the headers), if the large packets need to be retransmitted frequently, it is more efficient to send because smaller packets are less likely to have errors requiring the packet to be retransmitted. In addition, since the packets are smaller, retransmission of the defective packets (the packets that have errors) requires less of the network resources. When large packets are retransmitted, valid data is retransmitted with the errant data within the large packets. In contrast, when smaller packets are being transmitted, typically, less data needs to be retransmitted because the packet retransmitted is smaller (and the packet error rate is lower). Consequently, one of ordinary skill in the art would not use large packets because the inefficiencies due to retransmissions would be expected to outweigh the savings of sending larger packets.

In the case of the CBRS private networks operating in an LTE (Long Term Evolution 4G cellular network), eNBs and EPCs (Evolved Packet Cores) are typically deployed together to provide LTE cellular service for the enterprise customer devices. These devices can be regular mobile phones, other mobile devices, tablets, industry-specific devices such as POS (Point of Service) units, cameras, sensors, controls, etc. Some of the devices are high-end devices, and can support IPv4 (Internet Protocol, version 4) and IPV6 (Internet Protocol, version 6). These devices can support a wide variety of other features, such as 4×4 MIMO and carrier aggregation. Some devices can support multiple RATs (Radio Access Transmissions), including 5G NR (New Radio) cellular networks.

In the operator networks, when the Internet separates the AP and EPC, IPSec (Internet Protocol Security) tunnels are typically deployed. In such cases, the packet sizes can be large due to different header encapsulations for GTP/IPSec (GPRS Tunneling Protocol/IPSec), etc., where GPRS is the acronym for General Packet Radio Service. The packet sizes can exceed the typical Ethernet MTU of 1500. This results in a need to fragment and reassemble the packets that are too large to transmit in the network. In general, this fragmentation and reassembly can cause significant transmission delays and reductions in the throughput of the system.

In the intervening switches in the network, decisions about packet sizes and paths are based on the headers and the actual data that is switched, in cut-through mode. The intervening switches determine when and whether large packet sizes and reduced packet rates are also beneficial. In TCP (Transmission Control Protocol) traffic, for example, the MSS (maximum segment size) may be clamped in an intermediate node to reset the MSS values to values that reduce the problems created by the need to fragment packets (in some embodiments, MSS=MTU−TCP header−IP header). In some embodiments, MSS=MTU−IP (typically 20 bytes)−-TCP (header size, e.g., 20 bytes)−(TCP optional fields-variable bytes). In the case of UDP traffic, in some embodiments, payload size=MTU-IP (20 bytes)−UDP (usually the header is 8 bytes). The payload size can vary for other types of traffic (e.g., IPSEC/SCTP, etc.).

For example, assume that the MSS is clamped to 1280 bytes. In this way, traffic does not suffer fragmentation and reassembly even after adding the GTP/IPSec headers, and the packets can be forwarded in the fast path. However, in this example, every packet carries a payload of less than 1280 bytes instead of up to 1448 bytes. This is equivalent to a greater than 11% reduction in the Downlink (DL) application throughput.

On the RAN side, clamping the MSS causes an additional PDCP/RLC/MAC (Packet Data Convergence Protocol/Radio Link Control/Media Access Control) header to be added to each packet. These headers add relatively few bytes. Therefore, the overhead is not significantly increased. On the wireless side, multiple IP packets (Internet Protocol packets) are concatenated into Transport-Blocks and carried to the UE where the packets are demultiplexed and sent to the UE TCP/IP stack after removing PDCP/RLC/MAC headers.

FIG. 1 illustrates a network 100 that uses a 1500-byte MTU (FIG. 1) and the appropriate reduction for GTP/IP overheads, assuming that retransmissions are not needed. FIG. 1 can be compared to FIG. 2, which uses a 9000-bytes MTU. The network may include a UE 102, an AP 104, an EPC 106, and an enterprise system 108. At initial assembly, the packet includes a TCP header, which includes 20 bytes, and may include an additional 12 bytes indicating options. Before sending the packet to AP 104, the UE 102 may add the RLC, PDCP and MAC, as indicated in the UE's encapsulation 110 (FIG. 1)/210 (FIG. 2). Then, at the AP 104, 8 bytes of UDP data, 8 bytes of GTP data, and 20 bytes of IP data may be added as indicated in the encapsulation at the AP 112/212 to encapsulate the data before sending the data to the EPC 106. At EPC 106, the UDP and GTP data can be removed before sending the packet to the enterprise device 108, as indicated in the encapsulation at EPC 114/214. To transport a 9000-byte payload, the network 100 uses 6 packets (as indicated by the 6 transmissions 118a-g) of 1448 bytes+52-byte headers and an additional packet of 312 bytes+52-byte header. By contrast, were there no retransmissions, only a 9000-byte packet would need to be sent in one transmission (transmission 218), with the same overhead as just one of the transmissions 118a-g of 1448 bytes.

While using higher packet sizes on the DL for TCP-based applications, the TCP acknowledgments that need to flow back are also reduced. In the above example, to transport a set of 36k bytes, if 1400-byte packets are used, 14+ Uplink TCP-ACK packets need to be sent (the acknowledgments may be approximately 14×64˜=900 bytes in size). However, when the same 36k bytes are transported, using 4×9k TCP packets, just 2 Uplink TCP-ACK packets (2×64˜=125 bytes) are sent. Essentially, the traffic savings on UL can be more than 6 times, up to 85%, and while using IPV6 for UE's. The effective savings for UL overhead are even higher.

As a result of the higher MTU at the TCP level, the Uplink demand (packets/byte) is reduced. The reduction is significant and reduces the number of bytes that need to be sent, even if the DL/UL configuration is DL-centric, such as in the CBRS LTE-TDD (CBRS LTE-Time Division Duplexing) systems.

Also, in typical operator/service-provider networks, the extra packet headers are added to the end-user byte count/month. However, in the private LTE networks better transport efficiency increases the throughput, etc., and results in better user experiences (although the greater the throughput, the higher the transmission speeds and the greater efficiency contributes to a better user experience-a better user experience is valued more than improving any individual performance parameters).

The packet rate savings are applicable to both AP and EPC nodes while processing GTP and SCTP (Stream Control Transmission Protocol) traffic.

Also, for the AP, the packet transmission rate reduction reduces the number of scheduling triggers, such as buffer occupancy updates and PDCP (Packet Data Control Protocol) cipher. When ciphering and performing cryptographical operations, typically DMA (Direct Memory Access) transfers are used, instead of having a CPU (Central Processing Unit) initiate multiple small-packet transfers, and usually larger packet sizes are beneficial (for DMA transfers).

When the UEs operate in bad SINR (Signal-to-Interference-and-Noise Ratio) conditions, even though more retransmissions occur at the HARQ (Hybrid Automatic Repeat Request) level, the service provided is still acceptable. However, if the RLC level retransmissions occur more frequently, and consequently, the entire 9k higher layer TCP packet needs to be retransmitted rather than retransmitting only a failed smaller packet (amongst the 6-7 of the smaller MTU TCP packets of sizes 1500 and 312 bytes). Consequently, the RLC level retransmission penalty is greater with larger packet sizes and the RLC level retransmission penalty may become an issue when the UE 102 moves between high SINR and low SINR conditions.

When packets are dropped in the core, or if the RLC-retransmissions fail to recover the packet losses in the RAN, the larger-size packets require retransmissions of the entire packet (as compared with a selected number of retransmissions amongst the 6-7 smaller-sized packets). However, currently (in the prior art), it is not practical to send messages using larger message sizes, because the likelihood of the packet being dropped is too high and the penalty of retransmitting the larger packets is too great.

Basic Operation with Normal MTUs

FIG. 3 illustrates a network 300 having a static setting of 1500-byte MTU in both core and RAN (similar to the prior art). The following describes some aspects of the basic operation that occur with the normal MTU size. In the network 300, the MTU of 1500 is used to establish packet-size transactions that avoid fragmentation/reassembly at the IPV4 level. Throughout this specification, although numerical values are given, the numerical values are just examples. In practical applications, the numerical values for the packet sizes may be different depending on encapsulations, UE protocols and core-network configurations used.

### SUMMARY

Various embodiments of a method and apparatus are disclosed. In some embodiments, the EPC configures the Core-network to use higher MTUs for messages sent between the Core-network and AP. Also, the higher MTU is used in a wireless RAN segment of the network, and the EPC dynamically adjusts the packet sizes according to the UE capabilities and Radio-conditions (in some embodiments, the higher MTU is the maximum available MTU, which in some embodiments is 9000 bytes).

Co-locating network elements and using network elements from the same vendor facilitates reconfiguring network devices for higher MTUs. Using higher packet sizes provides increased application throughput, lower packet rates, fewer uplink acknowledgments, etc. Some issues that arise when using a higher MTU include (1) many parts of the network need to support any necessary retransmissions and (2) retransmitting a large packet wastes resources, especially on wireless networks. To take into account network packet losses and airlink issues, the system includes a dynamic method for setting packet sizes and MTU settings. The system allows the use of different MTUs and different packet sizes for each UE, flow and direction of traffic flow. In some embodiments, different MTUs and packet sizes are used for UL and DL.

Initially, the CBRS network (including traffic servers) and the UE are configured for higher MTUs and the EPC and eNodeB/gNodeBs, are tuned for handling large packet sizes.

However, the UE may not be capable of communications that use the higher MTU. So, initially, if there are any DL packets sent to the UE, those packets are prefragmented by the EPC to a low-MTU and sent the traffic toward the UE.

Regarding the difference between fragmentation and prefragmentation, during fragmentation, the MTU is checked and then the packet is divided into specific sizes, attaching a header for each fragment. Sometimes fragmentation cannot be performed at intermediate nodes, because only the first packet has a layer4 header, other packets have only fragment headers. During fragmentation at an AP (or 5GC), once a tunnel header is added to an incoming packet, the size may exceed the MTU. So, first the incoming packet is fragmented (based on the combination of the MTU and additional header overhead resulting from the tunnel and other possible sources), then the tunnel header is added, and the message is forwarded. All the prefragmented packets have 5GC-AP layer4 headers. Intermediate nodes also do not have issues, since the prefragmenting divides the packet into smaller fragments than fragmenting to ensure that when all the headers are added for the entire end-to-end path (e.g., the layer 4 header, the tunnel header and any other header), the fragment does not exceed the MTU.

By contrast, in at least some embodiments, even initially, UL packets from the UE are processed, as-is (for example, the UE may have already determined that the network is capable of processing large packets and start sending large packets immediately). If the UE is capable of using the higher MTU and the UE negotiates a TCP connection with a High-MSS value, then the EPC sends the “whole packets,” as-is, towards the UE, without prefragmenting the packets into smaller packets (UL packets from the UE continue to be processed, as-is). For uplink traffic, the UE is configured for packet sizes of up to a maximum size supported by the enterprise network (i.e., 9000 bytes, if the UE is capable of the larger packet size), and then the system supports usage of the larger packet sizes for both UP and DL messages. In some embodiments, the MTU is set to the Minimum of (1) the Maximum UE-MTU and (2) the Maximum EPC-MTU.

After setting the MTU and configuring the UE and network for large packet sizes, the ECP monitors traffic to determine the rate of TCP retransmissions and, in some embodiments, the rate of RLC retransmissions. The EPC detects TCP retransmission/packet loss by deeply inspecting the UE TCP-flow's SACK packets (Selective Acknowledgment packets) and determines whether the number of TCP retransmissions indicated in the SACK packet is above a first threshold value (a higher threshold). The phrase “deeply inspecting” the SACK packet refers to reading and analyzing the content of the SACK packet as opposed to reading just the header information of a packet, for example. Normal headers are processed by the AP, 5GC. However, normal packets carry UE traffic inside tunnel packets. So, deeply inspecting means inspecting these UE packets, which are also TCP IP packets going to/from different Internet servers (both in the uplink the downlink directions).

Based on whether RLC or TCP retransmission rate crosses an upper or lower threshold, the MTU is decreased or increased, respectively.

In some embodiments, the threshold for the retransmission rate is a threshold number of retransmissions.

### BRIEF DESCRIPTION OF DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 illustrates a network in which the network uses 1500 byte MTU and the reduction in the payload of a packet due to GTP/IP overheads.

FIG. 2 illustrates a network in which the network uses 9192 byte MTU and the reduction in the payload of a packet due to GTP/IP overheads.

FIG. 3 illustrates a network having a static setting of 1500-byte MTU in both the core and the RAN.

FIG. 4 illustrates a network with a static setting of 9000-byte MTU in both the core and the RAN and illustrates typical packet-size transactions used to avoid fragmentation/reassembly at the IPV4 level.

FIG. 5 illustrates a static setting with a higher level 9000-byte MTU in both the core and the RAN and illustrates typical packet-size transactions that are used to avoid fragmentation/reassembly at the IPV4 level.

FIG. 6 illustrates static settings in a network having a higher level 9000-byte MTU in both the core—and—the RAN and illustrates how the MTU/MSS settings are dynamically adjusted to different UE/flows.

FIG. 7 illustrates modern TCP transactions, in which the TCP-SACK indicates how to efficiently handle the re-transmissions.

FIG. 8 illustrates an embodiment of a method for dynamically adjusting the MTU used for communicating with a UE.

FIG. 9 illustrates a block diagram of an embodiment of an interface, which assists in implementing the methods of FIG. 7 and FIG. 8.

FIG. 10 illustrates a method of monitoring the retransmission rate (a step of FIG. 7).

FIG. 11 illustrates procedures associated with decreasing the MTU (another step of FIG. 7).

FIG. 12 illustrates procedures associated with increasing the MTU (another step of FIG. 7).

FIGS. 13 and 14 illustrate the procedures for a routing function that routes messages in the current system.

FIGS. 15 and 16 illustrate UE-Radio-health information that is gathered from each UE.

FIGS. 15 and 16 illustrate UE-Radio-health information that is gathered from each UE. The figures are not intended to be exhaustive or to limit the claimed invention to the precise form disclosed. It should be understood that the disclosed method and apparatus can be practiced with modification and alteration, and that the invention should be limited only by the claims and the equivalents thereof.

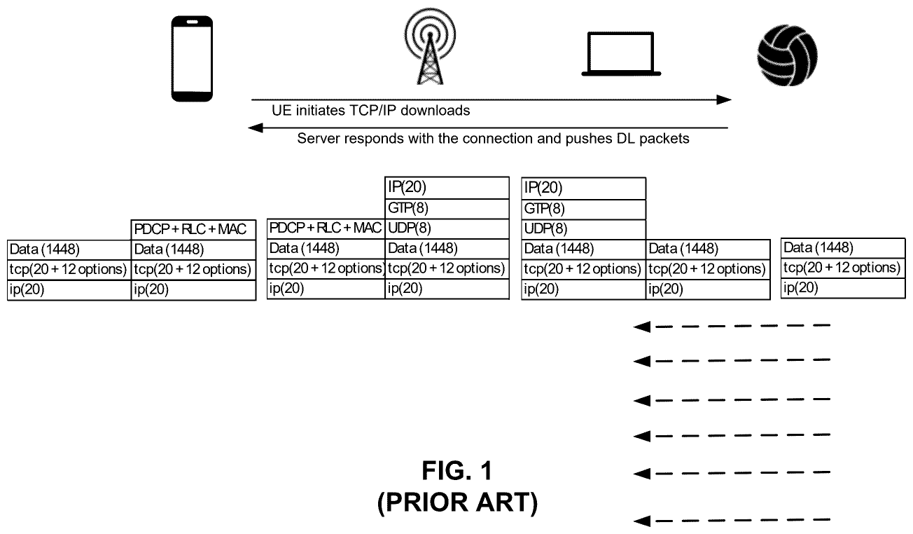

### DETAILED DESCRIPTION

In some embodiments, the packet size is dynamically selected for each of the UE's (User Equipment's) traffic flows, using statistical counters and predictions based on packet losses and observations of delays (delay observations), in the CBRS system in the enterprise networks.

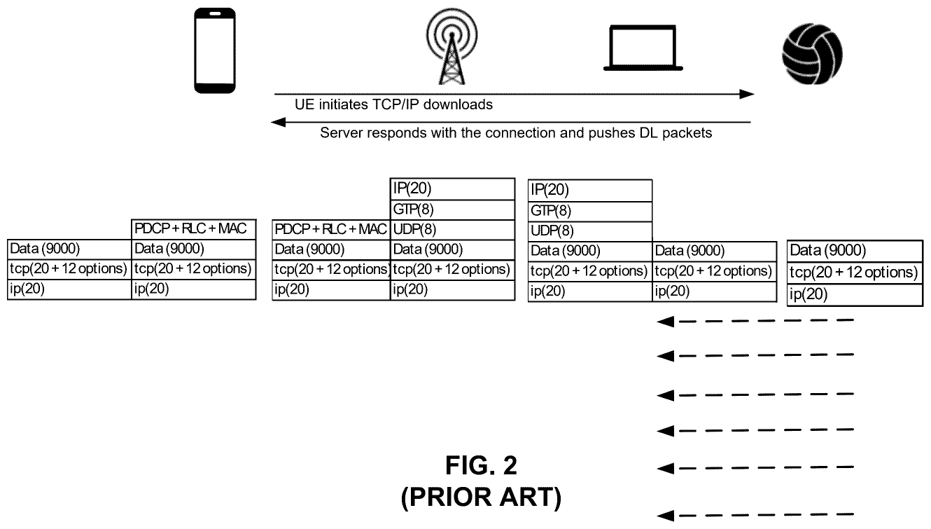

Concerning CBRS private LTE (Long Term Evolution) networks, in some embodiments, when the enterprise owns and operates the cellular network as well as the enterprise network 108, the AP 104 and EPC 106 elements are separated by a VLAN/L3 (Virtual Local Access Network/Level 3) router. In some embodiments, there is no IPSec link (Internet Protocol Security link). In some embodiments, it is possible that the MTU setting used in the network can be as high as 9192 bytes. If the core network uses 9192 bytes as MTU, for example, then the network architecture is that of FIG. 2. The server can send a single 9000-byte packet with a 52-byte header.

### Example of a Network Setup for a Large MTU

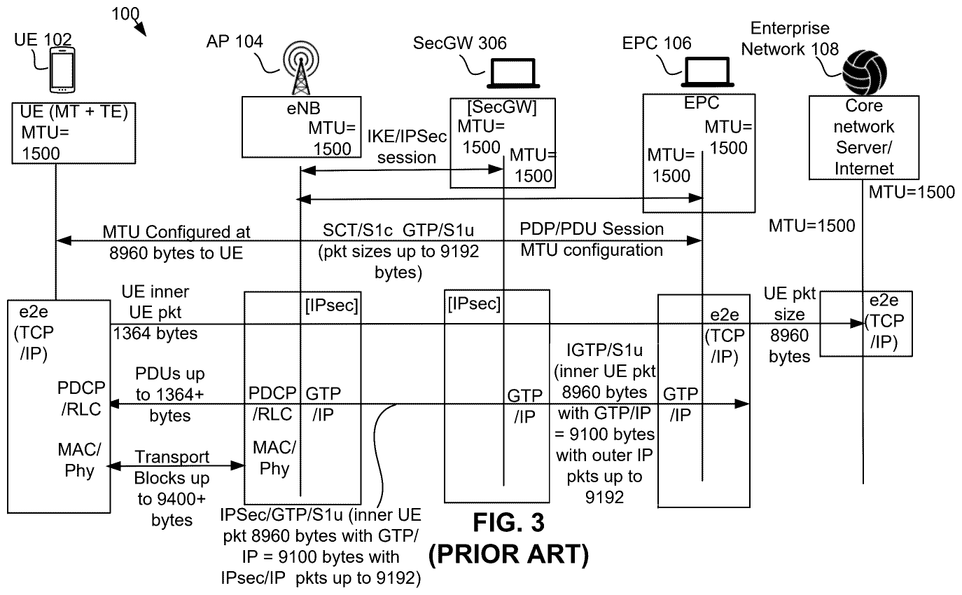

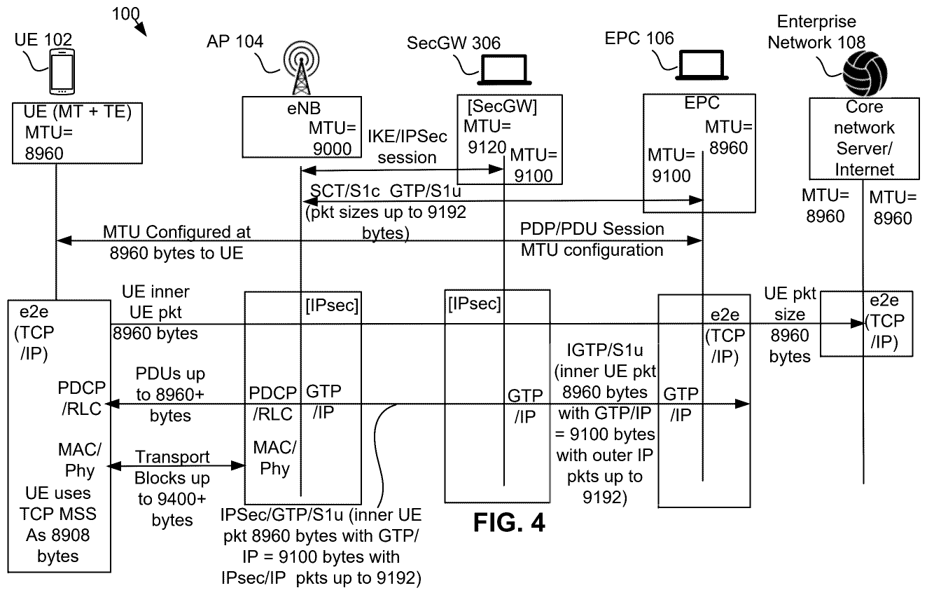

FIG. 4 illustrates the static settings with a higher level 9000-byte MTU in both the core and the RAN and typical packet-size transactions used to avoid fragmentation/reassembly at the IPv4 level. In FIG. 4, an Internet Key Exchange/IP security is established between the eNB (AP 104) and the Security Gateway (SGW or SecGW). An SCTP/S1c-GTP/S1u connection (or other tunnel connection) is established between the EPC 106 and the AP 104 with packet sizes up to a fixed maximum. A PDP/PDU MTU session configuration is established between EPC 106 and AP 104 with a large packet size. A PDP/PDU Session MTU is established between the UE 102 and the EPC 106. The inner UE packet, e2e (end-to-end) (TCP/IP), uses TCP with a larger MSS. Blocks are transported between MAC Phy (Medium Access Control Physical layer) of the UE 102 and AP 104. FIG. 4 is similar to FIG. 3. However, in FIG. 4, the MTU between the EPC 106 and the UE 102 is set to a higher value than in FIG. 3.

An Example of Some Communications within the Network Configured for a High MTU

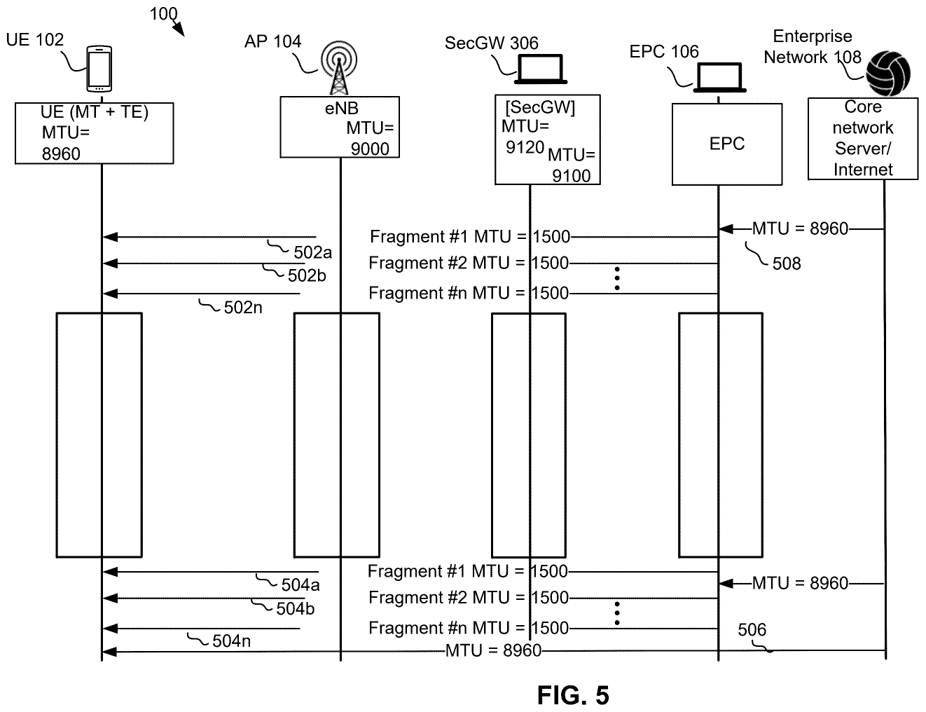

FIG. 5 illustrates some examples of communications occurring in the system of FIG. 4. Initially, in some embodiments, the MTU is set to a minimum MSS value, such as less than 1500 bytes (as indicated by messages 502a-n), until the capabilities of the UE 102 are determined. In general, assuming the network from the core network to the AP 104 is capable of a higher level MTU, and assuming that the system does not know whether the UE 102 is capable of using the higher MTU or not. The system begins with the assumption that the UE 102's MTU is at 1500 bytes and every downlink packet is fragmented (i.e., pre-fragmentation before GTP/IP/IPSec encapsulations) and then pushed/sent to the UE 102 after an IP-level fragmentation. Thus, initially, when the UE 102 begins communicating with the enterprise network 108, DL messages are fragmented at the EPC 106 into fragments 502a-n, in case the UE 102 is not capable of handling the larger size MTU. If the UE 102 is indeed not capable of handling the larger MTU, the EPC 106 continues to prefragment messages into fragments 504a-n. When the UE 102 begins TCP negotiations, the UE 102 at least starts with a hint MSS value of <1500 bytes, and the EPC 106 intercepts the communication. The EPC 106 marks that particular UE's MTU capability as being limited to 1500 bytes and continues with an IP-fragmentation strategy (sending messages 504a-n). If the UE 102 is capable of larger size MTUs, the MTU size is increased and future communications occur with the larger size MTU 506, and the size of the MTU is dynamically adjusted. When the maximum available MTU is in use, no prefragmentation occurs. When another MTU is in use, the messages are prefragmented to a size that is limited by the MTU in use. The static setting with a higher level, e.g., 9000-byte MTU in both the core and the RAN, and the typical packet-size transactions are used to avoid fragmentation/reassembly at the IPV4 level. FIG. 5 shows the same network and set of connections as FIG. 4, in which large packets that are sent from the core to the EPC 106 are fragmented into 3 fragments.

### Setting a Static Higher MTU System:

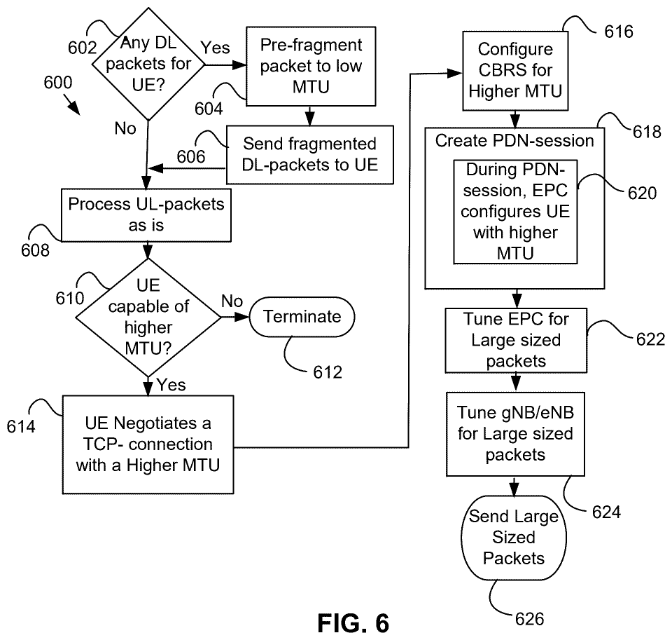

FIG. 6 illustrates an embodiment of a method 600 for initially setting up communications for a high MTU. Method 600 includes steps for setting up a static MTU configuration for using higher message size values, such as 9000 bytes, throughout the entire system. In some embodiments, the method 600 includes steps performed in the AP 104, the EPC 106, the intervening network elements and the UE 102.

Initially, a determination is made whether there are any DL packets destined for a UE 102 (decision 602). If there are DL packets destined for the UE 102, the DL packets are prefragmented to a low MTU (step 604) and then sent to the UE 102 (step 606). Whether or not there are DL packets, UL packets are processed, as is (step 608). A determination is made whether the UE 102 is capable of a higher MTU (step 610). For example, some UEs may provide a wide variety of information regarding the RAN capability (of the UE 102). In some embodiments, the information provided by the UE 102 is shared between the EPC 106 and the AP 104, such as information obtained from the UE 102 during attachments/UE handovers, etc. If the UE 102 is not capable of a higher MTU, method 600 terminates (step 612). If the UE 102 is capable of a higher MTU, the UE 102 negotiates a higher MTU (step 614). The CBRS is configured for a higher MTU (step 616). The EPC 106/Core-network elements are set for the MTU, accordingly, while setting up/modifying the packet session.

A PDN session is created (step 618). During the PDN session, the EPC 106 configures the UE 102 for the higher MTU (step 620). The EPC 106 is tuned for the higher MTU (step 622). The AP 104 is tuned for the higher MTU (step 624). The core network between (and including) the AP 104 and the EPC 106 and between (and including) the AP 104 and the enterprise servers, is configured to 9192 bytes, which are all configured with higher MTU settings, such as 9100 bytes (to cover for the GTP/IP—and optionally the IPSec/Vlan—encapsulation in the RAN network). If the IPV6 is used, an additional 32 bytes of overhead can be added as a buffer.

In some embodiments, the system buffer-pools/memory-pools of the AP 104 and EPC 106 nodes are re-tuned to support the larger-sized packets of 9192-bytes in various software/hardware components, crypto driver layers and networking driver layers.

If the AP 104 is configured to perform TCP-MSS clamping operations or packet-size reductions (in either direction), the clamping operations are disabled to allow the larger-sized packets. In some embodiments, the size of the message at which the MSS is clamped is increased.

In some embodiments, both the AP 104 and EPC 106 (SGW/PGW) are capable of fragmenting and reassembling (GTP-encapsulated) outer IP packets at wire speeds with little impact on performance. Communications proceed using the higher MTU (step 626).

In some embodiments, the EPC 106 system maintains statistics and counters on the count of bearers using larger MTU sizes, the count of bearers using smaller MTU sizes, the count of packets transferred using larger MTU packets in both DL and UL directions for the UEs (and an aggregate counter) and count the packets transmitted with fragmentation at IPv4/IPv6 levels in RAN. In some embodiments, counters are included for counting RLC retransmissions, and an analysis module is included that computes the average number of transmissions between retransmissions. In some alternative embodiments, the statistics are based on the time between retransmissions. Further, in some embodiments, to make the UE-specific radio-health information accessible, a communication interface (using header extensions) between the AP 104 and EPC (Evolved Packet Core) 106 is used.

In some embodiments, the interface uses an SCTP protocol for a 3GPP control-plane signaling and GTP protocol for a 3GPP data-plane (carrying UE packets inside a tunnel).

In some embodiments, the GTP/UDP/IP is only between 5GC and AP (headers are added before transferring packets between the AP 104 and EPC 106 and removed after processing the GTP information, which in some embodiments includes a tunnel ID to identify specific UE traffic). This GTP header has some extension fields, and the interface uses those GTP extension fields to signal information between AP and 5GC. So, if AP sends 5 packets and 3 packets were errors, the 3 error packets are retransmitted at the HARQ level. If there is still an error, the RLC protocol will trigger the retransmission of the packets. Consequently, the counter is incremented by 3 retransmissions for this UE (for example).

The information in the counter can be passed over to 5GC communications through the extension fields, so that the MTU can be adjusted accordingly in the subsequent packets. Alternatively, a separate channel (e.g., a proprietary channel) can be used instead of the extension fields for carrying the error information and related information.

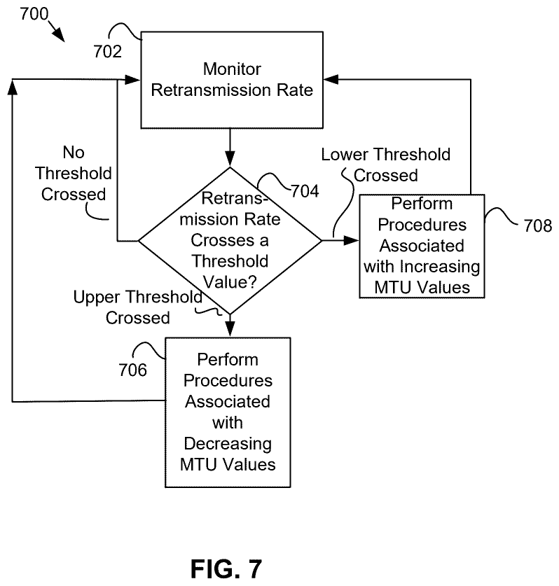

FIG. 7 illustrates an embodiment of a method 700 for dynamically adjusting the MTU used for communicating with a UE 102. In some embodiments, the method 700 is performed after the method 600. The retransmission rate of packets being sent to a UE 102 is monitored (step 702). A determination is made whether the retransmission rate falls below a lower threshold or rises above an upper threshold (step 704). The upper threshold and lower threshold depend on the current MTU. The higher/lower the current MTU, the higher/lower the upper and lower thresholds. If neither threshold is crossed, the method returns to monitoring the retransmission rate (step 702). In some embodiments, there is a maximum MTU and a minimum MTU that the EPC 106 handles. In some embodiments, if the communications with the UE 102 are conducted at the minimum possible MTU, the method 700 does not check whether the retransmission rate is above the higher threshold. If the retransmission rate falls below the lower threshold, the MTU is increased (step 706), and then the method returns to monitoring the retransmission rate (702). If the retransmission rises above the higher threshold, the MTU is decreased (step 708), and then the method returns to monitoring the retransmission rate (702).

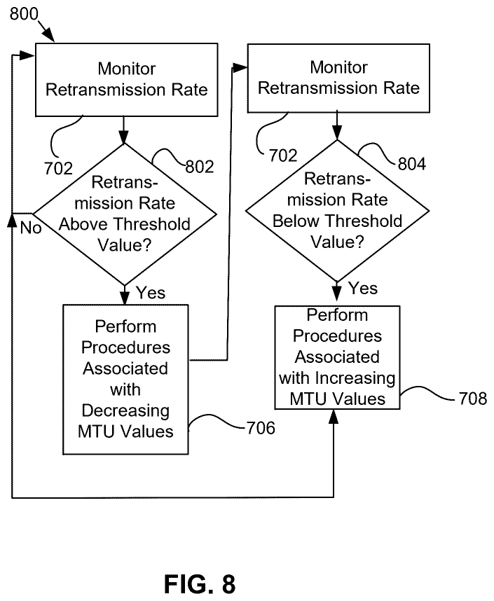

FIG. 8 illustrates an embodiment of a method 800 for dynamically adjusting the MTU used for communicating with a UE 102. The method of FIG. 8 oscillates between the maximum and minimum MTU. The method 800 represents a possible behavior of method 700. If the system is currently using the maximum MTU, the method 800 checks to see whether the retransmission rate falls below a lower threshold (step 802). If the system is currently using the minimum MTU, the method 800 checks to see whether the retransmission rate rises above an upper threshold (step 804). In some embodiments, determinations 802 and 804 are part of the determination 704.

### Interface for Monitoring Retransmissions and Determining an MTU Value

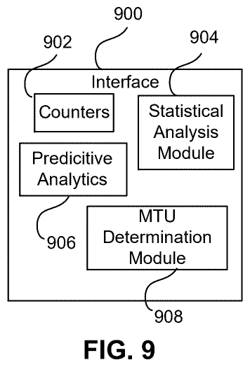

FIG. 9 illustrates a block diagram of an embodiment of an interface 900, which assists in implementing methods 700 and 800. Interface 900 includes counters 902 for tracking how many retransmissions occur between a given number of attempted transmissions. Statistical analytics 904 computes statistical values related to the retransmission rate of the retransmissions counted by counters 902. In some embodiments, statistical analytics 904 computes statistical values related to how the retransmission rates have varied with time. Predictive analytics 906 computes trends and expected changes in the retransmission rate based on statistical analytics 904. MTU determination module 906 determines what value to set for the MTU, based on the retransmission rate and, in some embodiments, based on the predictive analytics 906.

In some embodiments, the EPC 106 maintains and stores the table below or information, such as in the table below.

| | | | | | | Total- | | Re- |
|---|---|---|---|---|---|---|---|---|
| | | | | | prevAck- | received- | Total | transmission |
| UE-IP | UE-port | Server-IP | Srvr-port | Time | Seq-num | bytes | retransmissions | percentage |
| U1 | Up1 | S1 | Sp1 | T1 + 1 sec | prevAck1 | | | A11 |
| U1 | Up1 | S1 | Sp1 | T1 + 2 sec | prevAck2 | | | |
| U1 | Up1 | S1 | Sp1 | T1 + 3 sec | prevAck3 | | | |
| U1 | Up2 | S1 | Sp2 | T1 + 1 sec | | | | A12 |
| U1 | Up2 | S1 | Sp2 | T1 + 2 sec | | | | |
| U1 | Up2 | S1 | Sp2 | T1 + 3 sec | | | | |
| U1 | Upn | Sn | Spn | T1 + 1 sec | | | | A13 |
| U1 | Upm | Sn | Spn | T1 + 2 sec | | | | |
| U1 | Upm | Sn | Spn | T1 + 3 sec | | | | |

In some embodiments, the EPC (network) monitors the UE (UE-traffic/TCP/IP) and determines how many ACKs/NACKs (acknowledgments/non-acknowledgments) are received from each UE to each server. For the information about the UE traffic, the errors (e.g., number of packets dropped) for the UE are estimated, and the MTU is adjusted accordingly. The monitoring and estimating of the transmissions at the UE and maintaining the above table does not require the interface to AP.

However, the estimate and determination of the MTU using the above table can be very involved and can be simplified using the interface between EPC and AP. When using the interface, the GTP extension header is inspected to derive statistics/counters from the AP for specific UEs. The statistical information includes information related to the wireless performance, which in some embodiments includes error rates, retransmission rates and coding rates (data-vs-redundancy information), from which an appropriate MTU is estimated and used for that UE.

Every measurement interval, the retransmission percentages of all of a specific UE's TCP connections are aggregated, and the average ratio is determined (e.g., (A11+A12+A13)/3). If this ratio is high (say 5%) over multiple measurement intervals (for example, 3 measurements of 8 attempted transmissions each), it means either the network or the UE 102 has a noisy connection with many packet drops and if at that time, the UE/network is using a higher-MTU/MSS setting for that UE 102, the EPC 106 considers downgrading this UE 102 for a lower MTU/MSS setting for future TCP-flows and begin pre-fragmenting the packets to lower MTU/MSS values.

Procedures Associated with Monitoring Retransmission

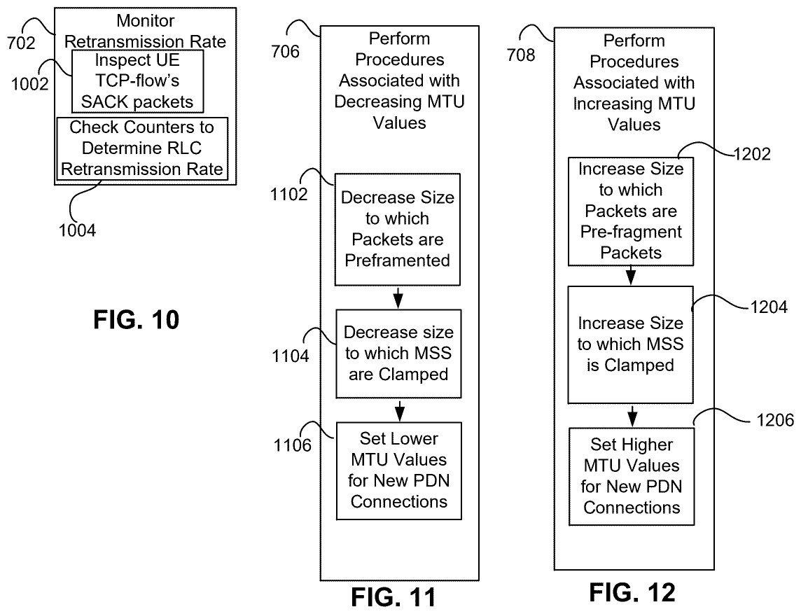

FIG. 10 illustrates a method of monitoring the retransmission rate (step 702). In some embodiments, SACK packets of the UE's TCP flow are inspected to determine the number of packets dropped (step 1002). The SACK contains a list of packet numbers representing the packets for which acknowledgments were received and the packets that were transmitted. In some embodiments, the counters are inspected to determine the number of retransmissions 902 that occurred between a given number of transmissions (or, in an alternative embodiment, during a certain time period) (step 1004).

As an example of how the TCP SACK packets track retransmissions, the server pushes/sends packets containing TCP-seq numbers x through x+n6. However, perhaps the UE 102 only received packets x and x+n1 to x+n2. Then the UE 102 indicates to the server, via TCP-SACK packets, that it has received up to sequence number x, and it has received some segments between x+n1 and x+n2 but is missing segments between x and x+n1. In some embodiments, the packets received are indicated by providing a list of the sequence numbers received or other equivalent information. Similarly, the UE 102 could also send TCP-SACKs indicating gaps in the reception and request the server to retransmit the missing messages.

The EPC 106 is configured to perform deep packet inspections of the UE TCP packets between UE 102 and the server for every UE's TCP connection/flow. On reception of every ACK-packet containing SACK information, The EPC 106 calculates the re-transmission percentage as

$$retx \% = \text{} \frac{retransmissionBytes}{totalBytes} = \frac{( x + n 1 - ( x ) ) + [ x + n 3 - x + n 2 ] + [ x + n 5 - x + n 4 ]}{( x + n 6 )}$$

Where x=x-prevACK and prevACK=1^{st} ACK sequence number (OR) ACK-sequence-number seen at the start of a time window. In some embodiments, the information associated with interface 900 is constructed from the SACK information.

Procedures Associated with Decreasing the MTU

FIG. 11 illustrates procedures that are associated with decreasing the MTU (step 706). The size to which packets are prefragmented is decreased (step 1102). In some cases, such as where the MTU was at the maximum value that the EPC 106 handles (method 800), prefragmenting is imposed, where previously there was no prefragmenting. The size to which the MSS is clamped is decreased (step 1104). In some cases, where no MSS clamping was previously being implemented, such as when the MTU was previously at the maximum value that the EPC 106 handles (method 800), MSS clamping is first imposed. Also, the lower MTU chosen by the MTU determination module 906 is the value to which the MTU is set for new PDU connections (step 1106).

Procedures Associated with Increasing the MTU

FIG. 12 illustrates procedures associated with increasing the MTU (step 708). The size to which packets are prefragmented is increased (step 1202). In some cases, such as where the new MTU is set to the maximum value the EPC 106 handles (method 800), prefragmenting is avoided. The size to which the MSS is clamped is increased (step 1204). In some cases, such as where the new MTU is set to the maximum value of the EPC 106 handles (method 800), the MSS clamping is stopped. Also, the higher the MTU that is chosen by the MTU determination module 906, the higher the value to which the MTU is set for new PDU connections (step 1206).

Procedures Associated with a Routing Function

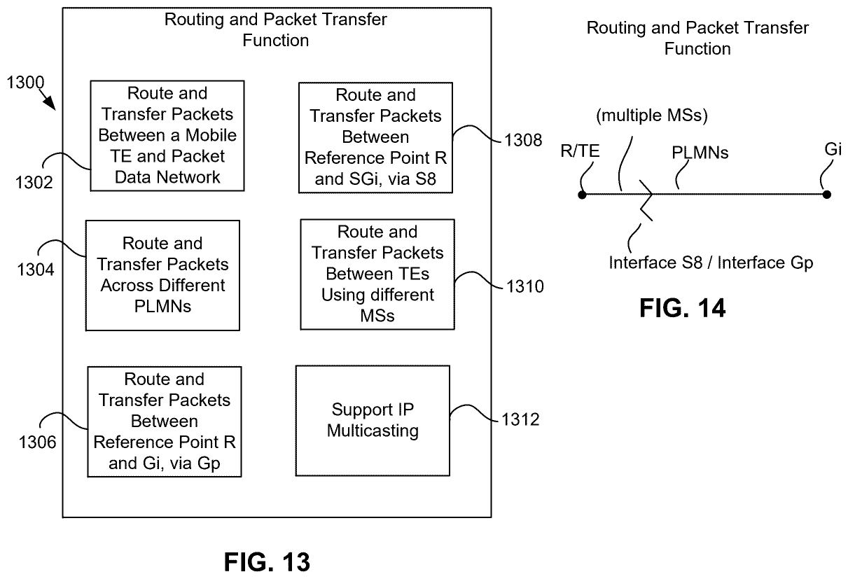

FIGS. 13 and 14 illustrate the procedures for a routing function 1300 that routes messages in the current system. Packets are routed and transferred between a mobile TE (Tunnel Endpoint) and a packet data network, i.e., between reference point R and reference points Gi or SGi (procedure 1302, see FIG. 14). Packets are routed and transferred between a mobile TE across different PLMNs (Public Land Mobile Networks) (procedure 1304), i.e., packets are routed and transferred between reference point R and reference point Gi, via interface Gp (procedure 1306, see FIG. 14). Between the SGSN and the GGSN, when using Gn/Gp, or between the SGSN and the SGW when using S4, PDP PDUs are routed and transferred with the UDP/IP protocols. The GPRS Tunnelling Protocol (GTP) transfers data through tunnels. A Tunnel Endpoint Identifier (TEID) and an IP address identify a GTP tunnel. When a Direct Tunnel is established, PDP PDUs are routed and transferred directly between the UTRAN (UMTS-Universal Mobile Telecommunications System-Radio Access Network) and the GGSN using Gn or between UTRAN and the SGW using S12. In some embodiments, on S5/S8 interfaces, PMIP (Proxy Mobile IPvsec6) is used instead of GTP (see 3GPP standard TS 23.402; entitled “Architecture enhancements for non-3GPP accesses”). For example, referring to FIG. 14, packets are routed and transferred between reference point R and reference point SGi, via interface S8 (procedure 1308, see FIG. 14). Packets are routed and transferred between TEs, i.e., between the R reference point, in different MSs (procedure 1310). Optionally, routing function 1300 supports/provides/causes IP Multicast routing of packets, via a relay function in the GGSN (Gateway GPRS Support Node) and PGW (Packet Gateway).

### Other Considerations

If certain devices do not support the larger packet sizes, then the full system should be capable of supporting both small-MTU UEs as well as large-MTU UEs. Similarly, the portion of the core network between the APs and EPC 106 should also support larger packet sizes. If a portion of the core network between the APs and EPC 106 does not support the larger packet sizes, the system uses lower MTU values.

Also, if the core network is only partially set to the higher MTU, then the system may have certain difficulties when the UEs that are attached via higher-MTU APs handover services of a UE 102 or when the UE 102 moves around to AP devices that are covered by lower-MTU network devices or vice-versa. In cases in which only part of the network is capable of using higher MTU messages, the UE 102 needs to be reconfigured with an appropriate MTU, and in case of ongoing transactions, those packets undergo IP-level fragmentation and re-assembly in AP 104 and EPC 106, which can negatively impact performance. In some embodiments, the MTU settings for UL packets, DL packets and different flows to the same UE 102 are different.

The PDP PDUs (Packet Data Protocol Packet Data/Distribution Units) shall be routed and transferred between the MS (Mobile Station) and the GGSN or PGW as N PDUs. The terms MS and UE are used interchangeably unless indicated otherwise. To avoid IP layer fragmentation between the MS and the GGSN (GPRS Support Nodes) or PGW, the link MTU size in the MS should be set to the value provided by the network as a part of the IP configuration. The link MTU size for IPV4 is sent to the MS by including the MTU size in the PCO (Protocol Configuration Option, see TS 24.008, which is incorporated herein by reference). The link MTU size for IPV6 is sent to the MS by including the MTU size in the IPV6 Router Advertisement message (see IETF RFC 4861 IPV6 Neighbor Discovery, published by the United States Department of Transportation, which is incorporated herein by reference).

When using a packet data network connection of type “non-IP” (see clause 4.3.17.8 of TS 23.401 published by the 3rd Generation Partnership Project; entitled “Technical Specification Group Services and System Aspects; GPRS enhancements for E-UTRAN access,” which is incorporated herein by reference), the maximum uplink packet size that the MS uses may be provided by the network as a part of the session management configuration by encoding the MS within the PCO (see TS 24.008 published by the 3rd Generation Partnership Project; entitled “Technical Specification Group Core Network and Terminals; Mobile radio interface Layer 3 specification; Core network protocols; Stage 3,” which is incorporated herein by reference). In some embodiments, to provide a consistent environment for application developers, the network uses a maximum packet size of at least 128 octets (or bytes) (in this embodiment, the maximum packet size applies to both uplink messages and downlink messages).

In some embodiments, the network configuration ensures that for PDP type IPv4v6 and the link MTU values provided to the UE 102, via the PCO, and included in the IPV6 Router Advertisement message, are the same. In some embodiments, when the link MTU values are not provided to the UE 102, the MTU size selected by the UE 102 is unspecified.

When the MT (Mobile Terminated message) and the TE are separated, e.g., a dongle-based MS, it is not always possible to set the MTU value based on information provided by the network. In some embodiments, the network has the capability of transferring N-PDUs containing PDP PDUs, where the PDP PDUs are of 1500 octets, between the MS and GGSN/P-GW.

In some embodiments, when the TE is separated from the MT, the TE can configure the communication for the desired MTU itself, which is out of the scope of 3GPP standardization procedures. Thus, even when the MT component in the terminal obtains MTU configurations from the network, the behavior of the MS, considered as a whole, may not always employ the MTU of the MTU configuration of the network. Many terminals have a separate TE, and the TE component is configured by default to use an MTU of 1500 octets.

In some embodiments, in which the network deployments have an MTU size of 1500 octets in the transport network, providing a link MTU value of 1358 octets to the UE (User Equipment).

In some embodiments, a link MTU value is provided during the establishment of each PDN connection (e.g., as a part of the session management configuration information).

In some embodiments, PDP type PPP is supported only when data is routed over a GGSN employing the Gn/Gp interfaces (the interface between GGSN and SGSN). In some such embodiments, a PGW supports a PDP type IPv4, IPv6 and IPV4/v6 only.

Between the 2G SGSN and the MS, PDP PDUs are transferred with SNDCP (Sub-Network Dependent Convergence Protocol). Between the 3G SGSN and the MS, PDP PDUs are transferred with GTP U and PDCP.

For other UEs that use a higher MSS value (such as 8960 bytes), EPC 106 allows a full 9000 bytes for higher MTU traffic without resorting to fragmentation. The UE 102 is allowed to monitor link performance and traffic rates and is allowed to choose a mechanism to determine the MTU and TCP-MSS values, independently of the EPC 106's determination. The UE 102 is allowed to determine desirable packet sizes and TCP-MSS values for messages, independently of the EPC 106.

In addition, if the UE 102 establishes a new PDN connection, the EPC 106 can set a higher MTU value for those PDN connections to force the UE 102 to use higher byte-count payloads.

### Dynamic MTU Management for Different UEs/Different Flows-Strategic

As mentioned earlier, it is also possible that it might be inefficient to use higher MTUs on select occasions. So, to provide relief and a fallback for those UEs the system provides different MTU/MSS settings for UEs and different flows for specific UEs. Having multiple available MTU settings facilitates dynamically determining MTU/MSS settings.

If the UE 102 initiates the TCP connection with the servers, the TCP-MSS negotiates to higher values, such as 8900 or more bytes. Consequently, the UE 102 is capable of accepting higher MTUs, and the EPC 106 marks the UE 102 as capable of the higher MTU (and suspends IP-fragmentation in the downlink direction) for all traffic towards the UE 102. The UE 102 and the servers continue to transmit TCP traffic, using the higher MSS values (up to 8900 bytes). The EPC continues intercepting and monitoring the traffic for retransmissions by monitoring the TCP-SACK messages from the UE 102.

The idea here is that if there are failures, retransmitting the entire 9000-byte packets results in unnecessary waste of airlink resources. If the IP packets are pre-fragmented and sent as 1500-byte packets or smaller, even if there are failures in airlink, the RLC-level recovery needs to deal with smaller size packets.

At the UE-TCP level, the 9000-byte packet is an 8900-byte DL packet and results in fewer ACK packets in the uplink, so the larger packet sizes in some embodiments can still be beneficial.

As the EPC 106 marks the UE's MTU capability as 1500 bytes, when the UE 102 tries to set up new TCP/IP sessions and the UE 102 and server try to negotiate TCP/IP MSS settings, the EPC 106 intercepts the traffic and re-clamps the MSS to a lower value, such as 1500 bytes. In addition, if the UE establishes new PDN connections, EPC can set a lower MTU value for those PDN connections to force the UE to use smaller-sized payloads.

The EPC 106 continues this UE-traffic IP-prefragmentation and TCP-MSS re-clamping to a lower MSS value if the TCP-packet loss is detected on other TCP-flow(s) for the UE 102.

In addition, if the UE 102 establishes a new PDN connection, the EPC 106 can set smaller MTU values for those PDN connections to force the UE 102 to use smaller-sized payloads.

In some embodiments, the EPC 106 continues monitoring the UE's TCP-Acks and as soon as the SACK-gaps reduce for a certain monitoring period, the EPC 106 restores the higher MTU values and restores the UE 102 to step-B) as above and avoids prefragmentation and lower MSS clamping for the UE-flows (the SACK-gaps are the gaps in the sequence numbers in the SACK, where the sequence numbers are the identifiers identifying acknowledgments of transmissions).

In addition, if the UE 102 establishes new PDN connections, EPC 102 can set higher MTU values for those PDN connections to force the UE 102 to use higher byte-count payloads.

The system should maintain counters on the number of UEs utilizing higher MTU versus the number of UEs utilizing lower MTU. The system-level statistics/counters track the number of UEs whose MTU settings switch from higher to lower value or vice-versa and characterize the trends and patterns. In addition to determining whether the number of retransmissions rises above a higher threshold or falls below a lower threshold, system-level statistics/counters are useful, for fine tuning the algorithm, such as for determining the threshold values for changing the MTU. For example, if the fluctuations in the retransmission rate are relatively small, then in some embodiments, the lower threshold retransmission rate is set to slightly below the percentage of retransmission that is below the percentage of the overhead that makes up the packet, whereas if the retransmission rate tends to fluctuate, the lower retransmission rate is set to a percentage of the overhead that makes up the packet minus one standard deviation.

### Dynamic MTU Management for Different UEs/Different Flows—Advanced

Note if the TCP-SACK is not supported or reliable, the EPC 106 may use other methods to determine the network behavior for deciding MTU/MSS values for the UE-flows. For other transport protocols, other elaborate methods of detecting protocol retransmissions between the UE 102 and the server may be performed.

Sometimes even without higher layer retransmissions, if the AP 104 detects more than a threshold number of RLC-retransmissions, the AP 104 again may reduce throughput, especially with large MTU size packets, and even in those cases also, the MTU/MSS setting of UE 102 shall be reverted to, so the packet has an effective payload<1500 bytes (One mechanism of detecting RLC retransmissions via RTT monitoring is described herein).

Depending on the TCP flow monitoring and other approaches disclosed, the EPC 106 may choose to set up the link for a chosen MTU value during different UE's bearer setup/modify or PDN set-up/modify operations, to increase or decrease the MTU values, to balance a higher payload efficiency with a higher MTU and packet-losses.

In some embodiments, additional MTU discovery using SCTP methods, via IPMTUD and PLMTUD, are performed by the UEs and the servers periodically for different flows, and, accordingly, decide on the MSS values. In some embodiments, depending on the end-to-end network (including the EPC/AP/intervening nodes) supported, the UEs and servers determine the MSS values, accordingly, independently of the proposal mentioned here.

### Rlc-Retransmission Detection Via RTT/Duplicate-Acknowledgment (Dup-Ack) Information Monitoring:

As described earlier RLC-retransmissions are detected more easily at the eNodeB level, but in this document, the CBRS UE's MTU/MSS setting is controlled at the EPC level (e.g., by the EPC) and so one approach is to communicate information including the UE's MTU/MSS settings and RLC-retransmission information from AP and EPC using a non-standard proprietary message. However, an alternate approach is to detect the RLC retransmission at the EPC itself by monitoring the RTT values on each of the UE's Protocol flows and adjusting the MTU/MSS setting for the UE flows accordingly.

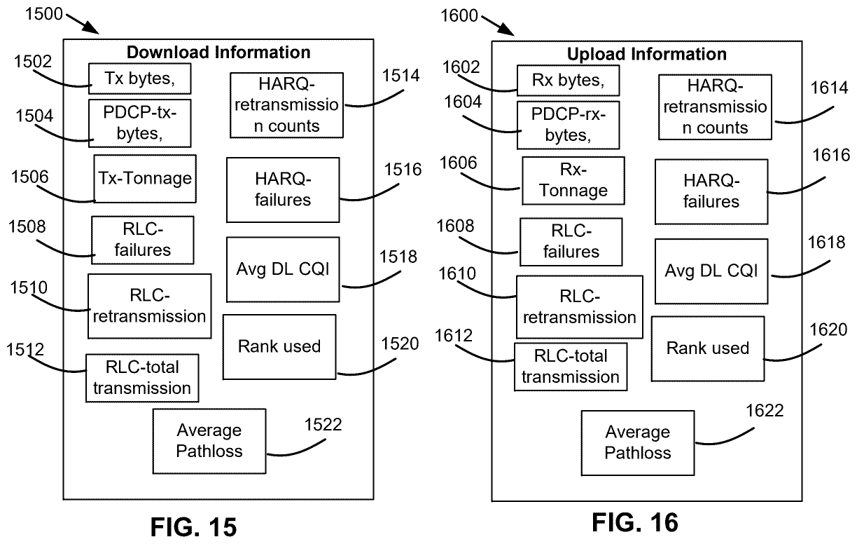

Now, consider the situation where there is a proprietary channel of communication (i.e., using S1 AP protocol extensions) available between the AP and the EPC 106 for periodically communicating about UE-specific Radio-health conditions about specific UEs. As illustrated in FIGS. 15 and 16, for each UE 102, the AP gathers UE-Radio-health information, such as:

DL: Tx bytes (1502), PDCP-tx-bytes (1504), Tx-Tonnage, RLC-failures (1506), RLC-retransmissions (1508), RLC-total transmissions (1510), Hybrid Automatic Repeat Request (HARQ)-retransmission counts (1512), HARQ-failures (1514), Avg DL CQI (Communication Quality Improvement) (1516), Avg Rank used (1518), Avg Pathloss (1520), etc. (where “rx” represents “transmission”). In some embodiments, the AP 104 also collects and stores UL information, including Rx bytes (1602), PDCP-rx-bytes (1604), rx-Tonnage (1606), RLC-failures (1608), RLC-retransmissions (1610), RLC-total transmissions (1612), HARQ-retransmission counts (1614), HARQ-failures (1616), etc. (where “rx” represent “receive”). In some embodiments, the AP 104 also collects and stores rc-connection time, Number-of-rrc-re-establishments, etc.

The EPC 106 is configured to receive the UE-Radio-health-information messages and calculate the number of UE-RLC-failures that occurred in a given number of transmission attempts in DL and UL directions.

Now, the EPC 106 is equipped to make decisions such as, if the number of RLC failures that occurred is a above a threshold value or if the number of RLC failures in the last 10 transmission attempts (or another number of transmission attempts), increases beyond a certain threshold, then EPC 106 considers downgrading the UE's to lower the MTU/MSS, and adjusts the size to which the packets are pre-fragmented and adjusts the size of the messages to which the MSS is clamped to one that is consistent with a lower MTU. Similarly, if the number of RLC failures (e.g., in the last 1 sec) decreases beyond a certain threshold for the next X transmission attempts or X next time windows (for example, the next 3 seconds), the EPC 106 considers restoring the UEs to higher MTU/MSS settings and avoiding pre-fragmentation and/or MSS-clamping with a lower MTU value.

### Additional Comments

In some embodiments, the EPC 106 also collects and stores values for the RRC-connection time (Radio-Resource-Control connection time) and the number of re-establishments of connections (and retransmissions), etc.

The EPC 106 is equipped to make decisions, such as downgrading the UE's to lower the MTU/MSS, and EPC 106 pre-fragments and/or clamps the MSS to values consistent with a lower MTU if the number of RLC failures in the last-1-see increases beyond a certain threshold.

Similarly, in some embodiments, if the number of RLC failures (or the number or RLC failures in the last X attempted transmissions) decreases beyond a certain threshold (or for the next X time windows), the EPC 106 considers restoring the UEs to a higher MTU/MSS setting and avoids pre-fragmentation and/or MSS-clamping to send messages using the lower MTU values.

In some embodiments, the system has the option to clamp the MSS in only one direction. In some embodiments, the system has the option to separately clamp flows in different directions to different MSS values. In some embodiments, the different directions are UP and DL.

The same concept is applicable in CBRS NR networks and Wi-Fi networks-either in standalone modes or even when these technologies are utilized concurrently (such as LAA (Licensed Assisted Access)/ENDC (Evolved New Radio Dual Connectivity)/Carrier-aggregation) modes. In some embodiments, similar benefits are realizable on other transaction-oriented protocols, such as NetBios and QUIC (Quick UDP Internet Connections, UDP is an acronym for User Datagram Protocol).

If the UE 102 does not support TCP-SACK, then the EPC 106 uses other methods of detecting TCP retransmissions.

In some embodiments, UE applications perform an IPMTUD (Independent Path MTU Discovery) and/or PLPMTUD (Packetization Level Path MTU Discovery), which are independent of the methods/systems described herein.

In some embodiments, for non-IPv4 and non-IPV6 bearers, other methods and systems are used. Although the specification discusses checking for thresholds for the number of retransmissions, in other embodiments, the retransmission rates are checked and the thresholds that are set are for the retransmission rate. In some embodiments, the retransmission rates are computed based on the number of retransmissions in a given in a given number of transmission attempts.

Although the disclosed method and apparatus are described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above-disclosed embodiments.

Terms and phrases used in this document, and variations thereof, unless otherwise expressly stated, should be construed as open-ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping but rather should be read as “and/or” unless expressly stated otherwise. Similarly, a group of items linked with the conjunction “or” should not be read as requiring mutual exclusivity among that group but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method comprising:
dynamically adjusting a Maximum Transmission Unit (MTU) of a flow between an Evolved Packet Control (EPC) and a User Equipment (UE) device by the flow at a rate that is faster than obtainable than by keeping the MTU fixed to a minimum MTU offered by the EPC, the dynamically adjusting including
(a) monitoring a Radio Link Control (RLC) retransmission rate;
(b) monitoring a Transmission Control Protocol (TCP) retransmission rate;
(c) determining
whether at least one of
(i) the TCP retransmission rate crosses a TCP retransmission rate threshold and
(ii) the RLC retransmission rate crosses an RLC retransmission rate threshold,
based on
(1) the monitoring of the RLC retransmission rate and
(2) the monitoring of the TCP retransmission rate; and
(d) if
(i) the TCP retransmission rate crosses a TCP retransmission rate threshold or
(ii) the RLC retransmission rate crosses an RLC retransmission rate threshold, adjusting the MTU.

2. The method of claim 1, further comprising:
(a) as part of establishing the flow,
(i) requesting capabilities of the UE device,
(ii) the EPC determining a tentative MTU for a Core-network for messages sent between the Core-network and the UE device,
(iii) the EPC setting a Radio Access Network (RAN) segment MTU in a wireless Radio Access Network (RAN) segment of the network based on the MTU determined for the core network, the RAN segment MTU being greater than or equal to the tentative MTU, and
(iv) the EPC dynamically adjusts packet sizes based on capabilities of the UE device and radio conditions; and
(d) before the UE device has been reconfigured,
(i) configuring a Citizens Broadband Radio Service (CBRS) network and the UE device for the tentative MTU as the MTU of the flow, and
(ii) tuning the EPC and eNodeB/gNodeBs for handling packet sizes consistent with the MTU of the flow.

3. The method of claim 1, further comprising before determining information about the UE device,
if there are any download (DL) packets,
(a) the EPC pre-fragmenting the DL packets to an MTU that is a minimum MTU offered by the EPC, wherein the pre-fragmenting includes fragmenting a packet without waiting for a failure in transmitting the packet, the EPC pre-fragmenting the DL packets before General Radio Packet Service (GPRS) Tunnelling Protocol (GTP)/Internet Protocol (IP)/IP Security (IPSec) encapsulations and
(b) sending DL packets that were pre-fragmented towards UE device;
(c) before the UE device has been reconfigured and before receiving information about capabilities of the UE device, processing Upload (UL) packets from the UE device without fragmenting the UL packets;
(d) as part of establishing the flow, if the UE device is capable of using a higher MTU than a current MTU, the UE device negotiates a Transmission Control Protocol (TCP) connection with a higher Maximum Segment Size (MSS) value, then the EPC sending larger size messages to the UE device, without prefragmenting the packets into smaller packets; and
(e) for uplink traffic, configuring the UE device for packet sizes of up to a maximum size supported by an enterprise network and the UE device; and
(f) setting the MTU a minimum of a first MTU and a second MTU, the first MTU being a maximum MTU the UE device is capable of and the second MTU being a maximum MTU that the EPC is capable of.

4. The method of claim 1, further comprising:
for uplink traffic, configuring the UE device for packet sizes of up to a maximum size supported by an enterprise network and the UE device.

5. The method of claim 1, further comprising:
after setting the MTU and configuring the UE device and network for larger packet sizes, the EPC monitoring traffic to determine a rate of Transmission Control Protocol (TCP) retransmission and a rate of Radio Link Control (RLC) retransmissions.

6. The method of claim 1, further comprising:
the EPC detecting Transmission Control Protocol (TCP) retransmissions and packet loss by deeply inspecting Selective Acknowledgment (SACK) packets of UE TCP flows and determines whether the TCP retransmissions indicated in the SACK packet are above a first threshold value, wherein the deeply inspecting includes reading and analyzing content of a body of the SACK packet.

7. The method of claim 1, further comprising:
determining whether an RLC retransmission rate crosses an upper threshold for the RLC retransmission rate, if the RLC retransmission rate crosses an upper threshold for the TCP retransmission rate, decreasing the MTU;
determining whether a TCP retransmission rate crosses an upper threshold, if the TCP retransmission rate crosses an upper threshold, decreasing the MTU;
determining whether an RLC retransmission rate crosses a lower threshold for the RLC retransmission rate, if the RLC retransmission rate crosses the lower threshold, increasing the MTU; and
determining whether a TCP retransmission rate crosses a lower threshold for the TCP retransmission rate, and if the TCP retransmission rate crosses the lower threshold, increasing the MTU.

8. The method of claim 7, if the MTU is set to a value less than a maximum MTU the EPC clamping the Maximum Segment Size (MSS) to a value consistent with the MTU for communicating with the UE device.

9. The method of claim 1, further comprising:
a packet size being dynamically selected for each UE traffic flow,
predicting packet losses based on statistical counters and
determining delays in transmissions based on acknowledgments,
in a Citizens Broadband Radio Service (CBRS) system in an enterprise network.

10. The method of claim 1, wherein the EPC includes a communication interface between an AP and the EPC for determining network conditions related to retransmission rates.

11. The method of claim 1, comprising:
establishing
an Internet Key Exchange/IP security connection between an Access Point (AP) and a Security Gateway (SGW), and
a Stream Control Transmission Protocol (SCTP)/S1c-General Radio Packet Service (GPRS) Tunnelling Protocol (GTP)/S1u connection between the EPC and an Access Point (AP) with packet sizes up to a fixed maximum.

12. The method of claim 1, comprising:
establishing a Packet Data Protocol Packet Data/Distribution Unit (PDP/PDU) MTU session between the EPC and an Access Point (AP) configured with a large packet size.

13. The method of claim 1, comprising:
determining whether at least a segment of a network from a core network to an Access Point (AP) is capable of higher level MTU; and
if at least the segment of the network from the core network to the AP is capable of higher level MTU, and
if capabilities of the UE device have not been determined, yet,
every downlink packet is fragmented, before GTP/IP/IPSec encapsulations and then pushed/sent to the UE device after an IP-level fragmentation.

14. The method of claim 1, comprising:
when the UE device begins TCP negotiations, the UE device including a hint value of a Maximum Segment Size (MSS) in a communication, the EPC intercepting the communication, and
the EPC storing an MTU capability of the UE device based on the hint value, if the UE device is limited to an MTU value that is less than a maximum MTU that a core network is capable of, continuing prefragmenting packets.

15. The method of claim 1 further comprising:
tuning memory pools of one or more Access Point (AP) nodes and one or more EPC nodes to support packet sizes consistent with an MTU that is greater than a minimum MTU offered by the EPC.

16. The method of claim 1 further comprising: tuning crypto driver layers and networking driver layers to larger packet sizes.

17. The method of claim 1, further comprising controlling, by the EPC, settings for the MTU and a Message Segment Size (MSS) of a UE device of a Citizens Broadband Radio Service (CBRS) by at least communicating information including the settings and RLC-retransmission information from an Access Point (AC) and the EPC using a non-standard proprietary message.

18. The method of claim 1, further comprising detecting the RLC retransmission at the EPC by monitoring Round Trip Transmission time (RTT) values for each flow associated with the UE device and adjusting the MTU and MSS settings for the UE device flows based on the RLC retransmission detected.

19. The method of claim 1, further comprising: an Access Point (AC) and the EPC periodically communicating information related to UE-specific Radio-health conditions associated with specific UE devices via an S1 Access Point (AP) available between the AP and the EPC, the information communicated including UE-specific Radio-health conditions associated with specific UE devices.

20. The method of claim 19, the information related to UE-specific Radio-health conditions including: values for amounts of data transmitted in a Download (DL) direction, amounts of Packet Data Convergence Protocol (PDCP) data transmitted in the DL direction, transmission-tonnage in the DL direction, information related to RLC-failures in the DL direction, a number of RLC-retransmissions in a DL direction, a number of total RLC-total transmissions, Hybrid Automatic Repeat request (HARQ)-retransmission counts in the DL direction, count of HARQ-failures in the download direction, a download Communication Quality Improvement (CQI), an average Rank used in the DL direction, an average pathloss, amount of data received in an upload (UP) direction, an amount of PDCP data received in the UP direction, received tonnage in the UP direction, RLC-failures in the upload direction, RLC-retransmissions in the UP direction, RLC-total transmissions in the upload direction, HARQ-retransmission counts in the UP direction, HARQ-failures in the upload direction, the AP also collects and stores radio resource control-connection time, and a number-of-radio resource control-re-establishments.
